(19) United States
(12) Patent Application Publication
(10) Pub. No.: US 2010/0038527 A1
(43) Pub. Date: Feb. 18, 2010

(54) Rotary Push On Encoder

(75) Inventor: David M. Madore, Vancouver, WA (US)

Correspondence Address: PATENTFORGE, 1725 SE 72ND, PORTLAND, OR, 97215, US

(73) Assignee: US DIGITAL LLC, Vancouver, WA (US)

(21) Appl. No.: 12/607,299

(22) Filed: Oct. 28, 2009

Related U.S. Application Data
(63) Continuation-in-part of application No. 12/060,241, filed on Mar. 31, 2008.

(51) Int. Cl. G01D 5/34

(52) U.S. Cl. 250/231.13

(57) ABSTRACT

Rotary encoders with push on components for determining speed and/or position of a rotating shaft are described. Also described are features for indexing an encoder to a shaft position.

### RELATED APPLICATIONS

This application claims priority to U.S. patent application Ser. No. 12/060,241 filed Mar. 31, 2008 titled “Encoder Hub to Disc Attachment Method and Apparatus” which is hereby incorporated by reference in its entirety for all purposes.

### BACKGROUND

The present disclosure relates generally to encoders and more specifically to magnetic and optical rotary encoders with components attached to shafts. References of interest that describe rotary encoders and attachments to rotating shafts include U.S. Pat. Nos. 4,893,812; 4,338,517; 4,756,654; 6,260,930; US Patent Publication 20050201825; German Patent DE1475035 and European Patent EP0353066.

### SUMMARY

Rotary encoders are used to track rotation speed and rotation position of various kinds of shafts. There are numerous configurations and technologies used in rotary encoders. In general, a codewheel including a bore and a magnet, coded pattern or other encoding means is installed on the shaft and rotates with the shaft. A sensor assembly is positioned proximate to the codewheel and fixed in place in relation to the rotating shaft. The codewheel and the sensor assembly are coupled and in response to rotation of the shaft and codewheel the sensor assembly generates an encoder signal. Encoders may be used with robots, stepper motors, wheeled vehicles or programmable shop machinery among many other applications.

This disclosure relates to rotary encoders including those that use encoding means such as a magnet or a disk with an encoding pattern. The encoding means may be part of a push on codewheel retained to a shaft without keys or set screws. This disclosure may also describe a rotary encoder with the second encoder component in its assembled position that can be indexed to a specific shaft position without the use of special tools. Push on codewheels may be configured as collets, caps or another component that can be assembled to a shaft and may include elastic, resilient or biased members or portions that hold the component to the shaft.

A rotary encoder assembly to operate with a shaft may be described here comprising a push on codewheel that may include a bore portion for accepting the shaft, retention means that deflect on accepting the shaft to frictionally retain the push on codewheel to the shaft and an encoding means. The assembly may further include a sensor assembly coupled with the encoding means to generate an encoder signal as a function of rotation of the shaft.

A rotary encoder assembly for determining the rotational position of a shaft in a shaft housing may also be described comprising a push on cap including a magnet, the push on cap frictionally retained to the shaft that rotates in relation to the shaft housing. The assembly may also comprise an encoder housing mounted to the shaft housing and including an electronics package functionally associated with the magnet that generates an encoder signal in response to rotation of the magnet and a lock ring for limiting rotation of the encoder housing.

For the purposes of this disclosure, retention means and biasing members will refer to elements with spring like material properties. In the described applications material deflection is substantially in the elastic region of force-deflection diagrams for selected component materials. Any deflection of the material under normal use may induce a bias that tends to return the material to its original position.

### BRIEF DESCRIPTION OF FIGURES

FIG. 1 is an exploded perspective view of an encoder assembly including a push on codewheel with encoding means and a sensor assembly.

FIG. 2 is a partial cross section of the push on codewheel and sensor assembly assembled to the shaft.

FIG. 3 is a perspective view of a push on codewheel with encoding means assembled to a shaft and associated sensor assembly.

FIG. 3A is a perspective view of an alternative configuration of a push on codewheel with encoding means assembled to a shaft and associated sensor assembly.

FIG. 4 is a partial cross section of the push on codewheel assembled to the shaft.

FIG. 5 is a cross section showing the profile of the bore portion of the codewheel that accepts the shaft.

FIG. 6 is a flow chart of steps that may be associated with assembly or use of a rotary encoder.

### DESCRIPTION

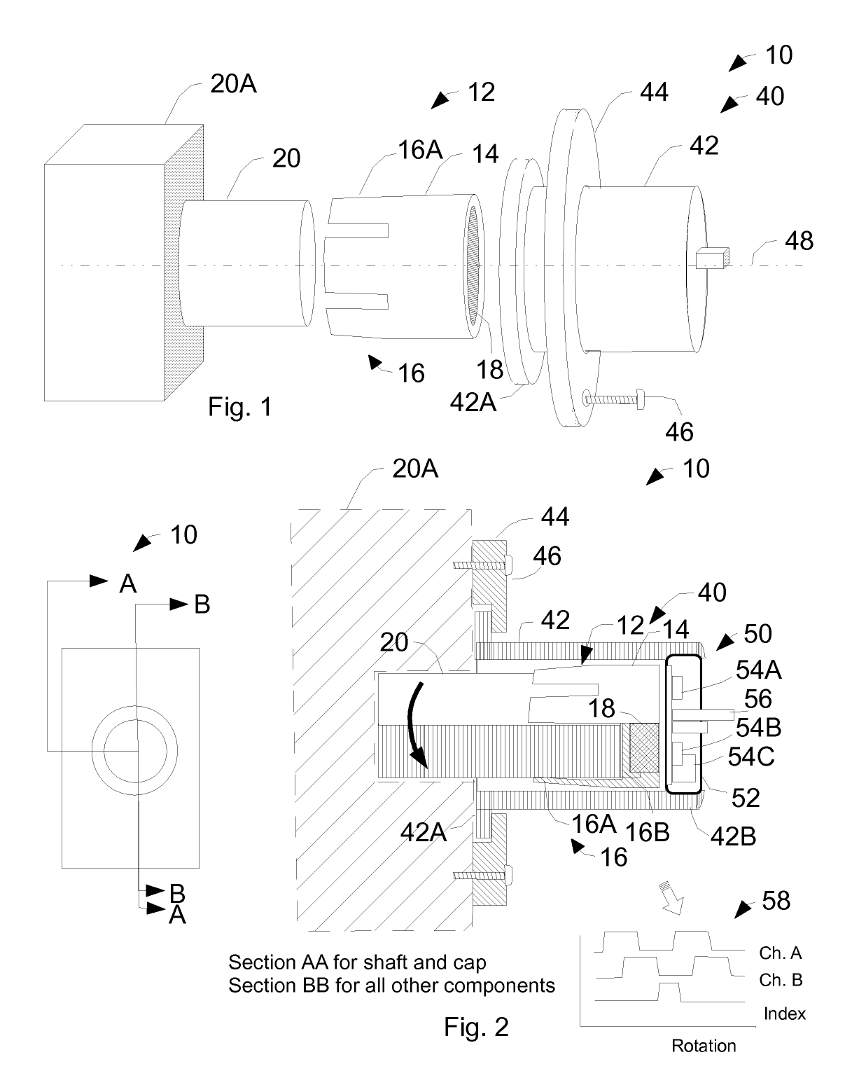

FIG. 1 shows an exploded perspective view of a rotary encoder assembly 10 including a push on codewheel or push on cap 12 with a cap housing 14 that may include a bore portion 16 and an encoding means 18. Cap housing 14 may be configured as a closed ended tube formed by bore portion 16 machined or formed into one end of cap housing 14. Bore portion 16 may include slits in the walls of housing 14 to form biasing members or first retention means or fingers 16A. Bore portion 16 with first retention means 16A may be configured to accept shaft 20. Shaft 20 may be driven from and mounted in a shaft housing 20A. Assembly 10 further includes encoder sensor assembly 40 with encoder housing 42, lock ring 44 and fastener 46. Encoder assembly 10 may be substantially oriented along a longitudinal axis 48.

FIG. 2 is a cross section of encoder assembly 10 showing push on cap 12 with cap housing 14 assembled to shaft 20 in partial cross section AA. Encoder sensor assembly 40 is shown in full cross section BB including housing 42, lock ring 44 and fastener 46 assembled to shaft housing 20A. Lock ring 44 may engage a mounting base portion 42A of housing 42 to retain housing 42 to shaft housing 20A.

Lock ring 44 when partially assembled with fastener 46 not fully engaged may allow housing 42 to rotate about longitudinal axis 48. Fully engaging fastener 46 may cause lock ring 44 to frictionally retain housing 42 so that it cannot rotate and housing 42 is fixed in place. Rotating housing 42 while partially assembled may allow encoder assembly 10 to be indexed so that a specific position of shaft 20 corresponds to a specific output from encoder sensor assembly 40.

Encoder sensor assembly 40 may further include sensor electronics or electronics package 50 comprising an electronics housing 52, first electronic component 54A, second electronic component 54B, third electronic component 54C and a connector 56 operably connected to the electronic components 54A and 54B. When assembled, electronic components 54A and 54B may be in proximity and be coupled to encoding means 18 and may functionally respond to rotational movement of encoding means 18.

For example, encoding means 18 may be a magnetic material that generates a magnetic field with first and second poles. Rotation of shaft 20 may cause the first pole and the second pole of encoding means 18 to alternately be in closest proximity to first electronic component 54A and second electronic component 54B respectively. Electronic components 54A and 54B may include a sensor such as a hall effect sensor, a wire coil or some other responsive element. Third electronic component 54C may be connected to electronic components 54A and 54B and accept signals generated by them. Third electronic component 54C may generate an encoder signal 58 as a function of the input. Additional processing equipment such as an rpm meter, a rotation counter or more complex motion control equipment may connect to electronics package 50 at connector 56 in order to access encoder signal 58 and determine the rotational speed and/or the rotational position of shaft 20.

Still referring to FIG. 2 push on codewheel or cap 12 may be configured to be frictionally retained on shaft 20. Cap 12 may be pushed on to shaft 20 and center itself along longitudinal axis 48 and/or shaft 20. First retention means 16A may be configured as a set of retention or biasing members. On assembly the fingers may deflect outwards to accommodate shaft 20. Elastic deformation or bias of retention means 16A may result in each finger exerting a substantially equal force radially on the shaft surface. Bore portion 16 may further include a face 16B at the end of the bore. On assembly to cap 12 the square end of shaft 20 may abut face 16B.

Mounting base 42A may be at a proximal end of housing 42. Housing 42 may be configured to accept electronics package 50 at a distal end of housing 42 such that it is seated on a shoulder or ring and below a rim section 42B. Rim section 42B may be plastically deformed to retain electronics package 50 within housing 42. Housing 42 may be substantially comprised of a metal that can be crimped or housing 42 may be substantially comprised of a plastic that can be heated and swaged to retain package 50. Other materials and processes may be used that achieve a similar result.

Shaft housing 20A, which is often a motor housing, has been specified here for mounting a sensor assembly, but any proximate surface may be used. Also a different combination of codewheel and sensor than a magnet and hall effect sensor may be used and fall within the scope of this disclosure. These components and configurations have been described here as examples only for clarity.

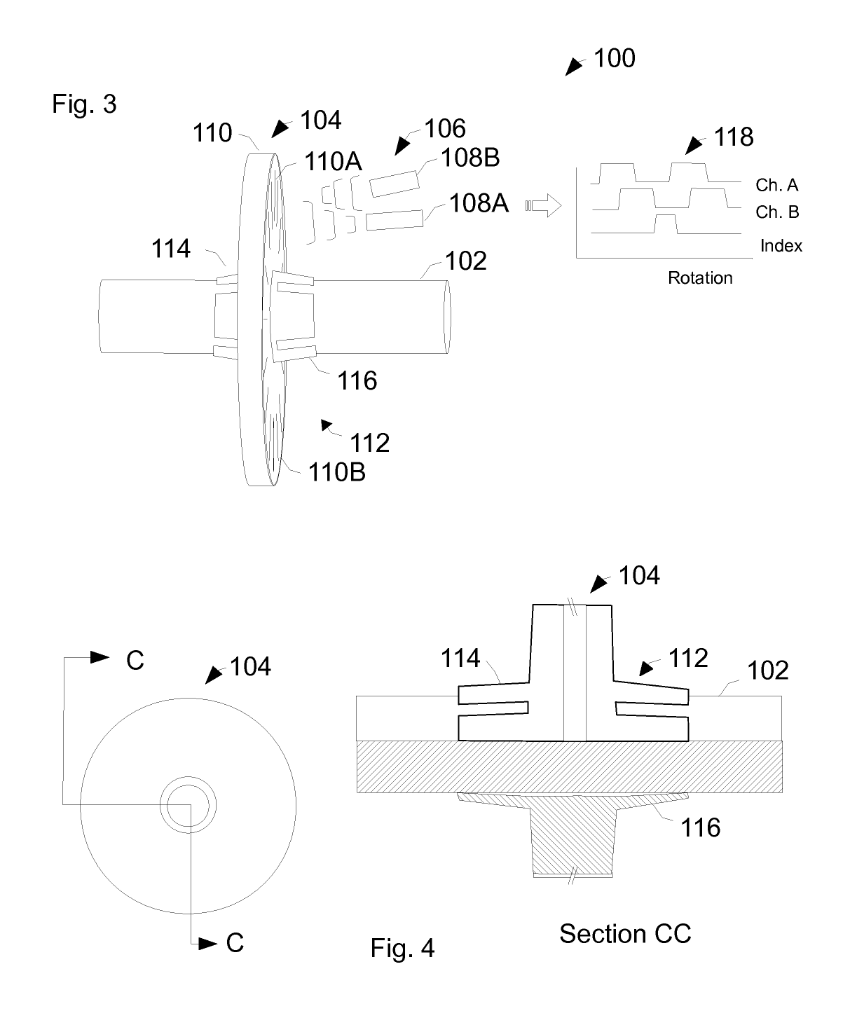

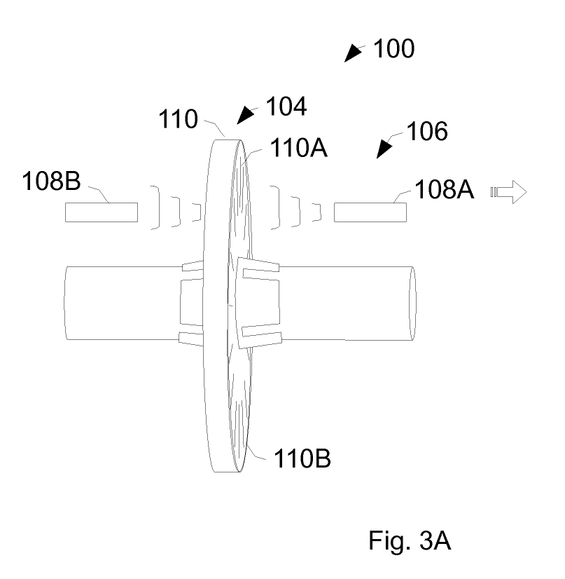

FIG. 3 is a perspective view of another configuration of a rotary encoder assembly 100 that includes a push on codewheel or push on codewheel disk 104 assembled to a shaft 102 in association with a sensor assembly 106 with light source 108A and light detector 108B. Push on disk 104 may include disk body 110 and bore portion 112 that includes first retention means or first fingers 114 and second retention means or second fingers 116 around a central bore that accepts shaft 102. First retention means 114 and second retention means 116 may be similar to retention means 16A of FIG. 1.

Push on codewheel disk 104 may incorporate encoding means 110B such as markings or a pattern on a face 110A of disk body 110. Encoding means 110B may be an overlay with an optical encoder or code pattern configured to attach to and rotate with disk 110. Encoding means 110B may operate with and be coupled to sensor assembly 106. Light detector 108B may respond to light reflected from a face 110A of disk 104. Markings on disk face 110A or the overlay with markings incorporated with disk 104 may intermittently interrupt light from source 108A reflected onto detector 108B as disk 104 rotates. This may generate an encoder signal 118 that is associated with the rotation speed and/or rotation position of shaft 102. While a quadrature signal is shown in signal 118 any kind of signal may be generated that may be compatible with processing equipment receiving signal 118 including PWM or analog.

FIG. 3A shows an alternative configuration of a rotary encoder assembly 100 including codewheel or push on disk 104 and and sensor assembly 106. Light source 108A and light detector 108B of sensor assembly 106 may be on opposite sides of disk body 110 which may be transparent. Encoding means 110B may alternately block and transmit light through disk 110 as shaft 102 rotates.

FIG. 4 is a partial cross section of push on disk 104 of FIG. 3. Push on disk 104 shown here again assembled to shaft 102 may include bore portion 112, left or first retention means 114 and right or second retention means 116. Push on disk 104 may be assembled to shaft 102 by deflecting first retention means fingers 114 until each finger 114 contacts the circumference of shaft 102. Pushing shaft 102 further into bore portion 112, second retention means 116 similarly deflect to accommodate shaft 102 until each finger contacts the circumference of shaft 102. Each finger of the retention means deflects elastically and applies a substantially equal radial inward force on the surface of shaft 102. In response, push on disk 104 is substantially centered on shaft 102.

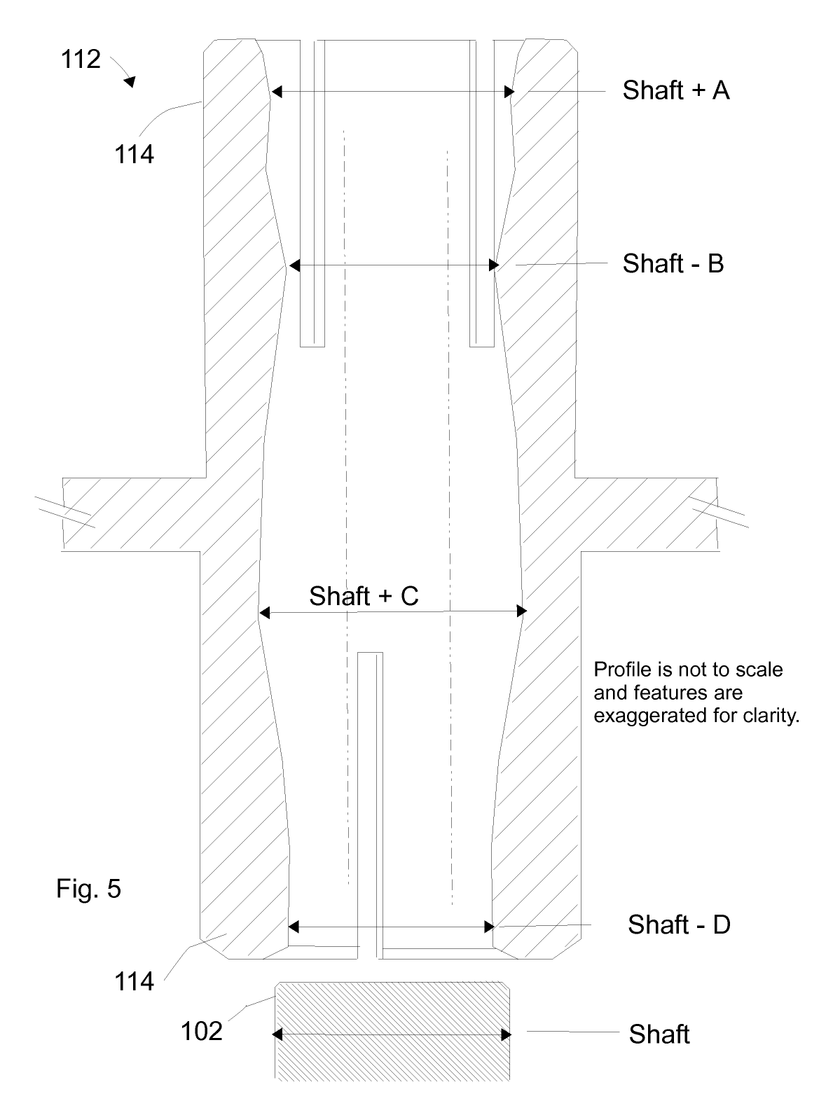

FIG. 5 depicts the profile of an example bore portion 112 with first retention means 114, second retention means 116 and associated shaft 102. The profile is not to scale and features are exaggerated for clarity. Indicated dimensions A, B, C and D may be any relatively small dimensions in relation to the shaft diameter that optimize shaft retention and friction. As shaft 102 is inserted through bore portion 112 first retention means 114 are configured with a diameter less than the diameter of shaft 102 and first retention means 114 deflect to admit shaft 102. As shaft 102 passes through bore portion 112 beyond fingers 114 and proximate to disk body 110, the diameter of bore portion 112 may be wider than the diameter of shaft 102. Further into bore portion 112 the diameter is again less than the diameter of shaft 102 and second retention means 116 may deflect to allow shaft 102 to pass through all of bore portion 112. Again, first retention means 114 and second retention means 116 may experience substantially elastic or spring like deflection and exert a substantially even normal force around the outside circumference of shaft 102.

The profile of FIG. 5 is an example and should not be considered a limitation. Any bore configuration that performs similarly falls within the scope of this disclosure. Slots in bore portion 112 that form the fingers of first retention means 114 and second retention means 116 may be in corresponding left and right positions and/or of the same depth. Alternatively, slot positions left and right may be offset from each other and/or may be of different depths.

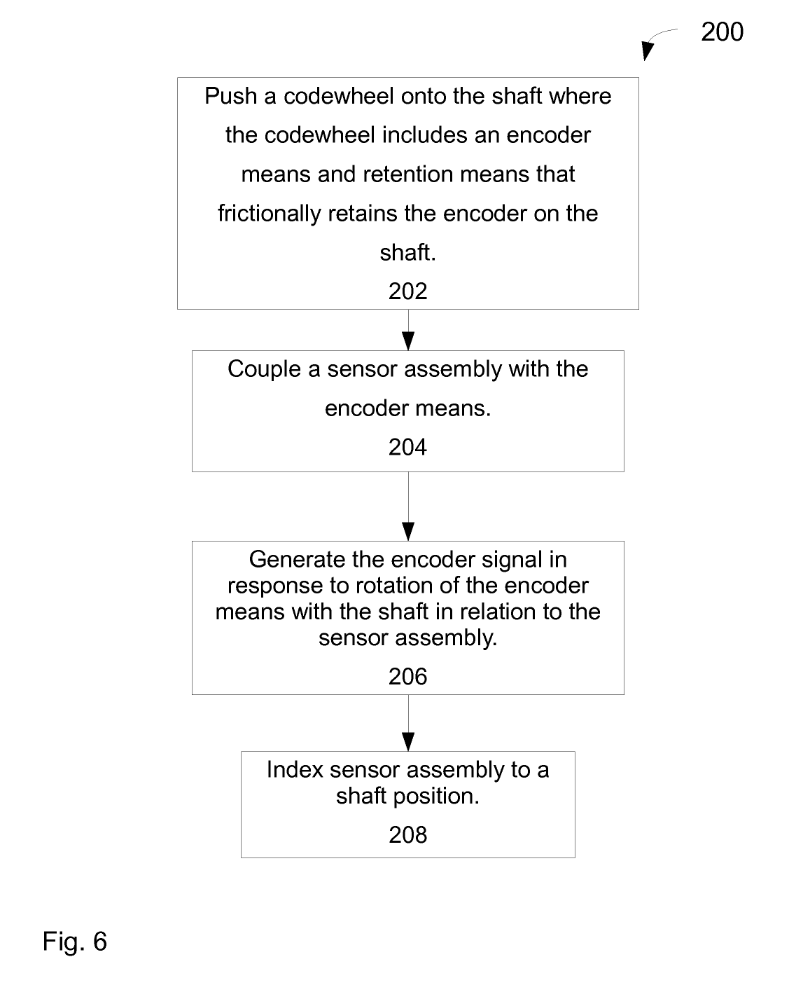

FIG. 6 is a flow chart describing a method 200 of generating an encoder signal of the rotation of a shaft comprising at step 202 pushing a codewheel onto the shaft where the codewheel includes an encoding means and retention means that frictionally retains the codewheel on the shaft, and at step 204 coupling a sensor assembly with the encoding means. At step 206 encoder signal 58 or 118 may be generated in response to rotation of the encoding means with the shaft in relation to the sensor assembly. Further and in an optional step, at step 208 the sensor assembly may be indexed to a shaft position.

The described system and assemblies are examples and are not to be used as limitations. Different numbers of slots or different dimensions and proportions may be used and still fall within the scope of this disclosure. Any suitable configuration or combination of components presented, or equivalents to them that perform a similar function falls within the scope of this disclosure.

This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. An appreciation of the availability or significance of claims not presently claimed may not be presently realized. Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

I claim:

1. A rotary encoder assembly to operate with a shaft comprising:
a push on codewheel including:
a bore portion for accepting the shaft;
retention means that deflect on accepting the shaft and frictionally retain the push on codewheel to the shaft; and
an encoding means; and
a sensor assembly coupled with the encoding means to generate an encoder signal as a function of rotation of the shaft.

2. The rotary encoder assembly of claim 1 where the sensor assembly includes a housing, a lock ring and an electronics package that generates the encoder signal in response to rotation of the encoding means.

3. The rotary encoder assembly of claim 2 where the encoding means generates a magnetic field and the electronics package includes at least one component responsive to the generated magnetic field.

4. The rotary encoder assembly of claim 1 where:
the encoding means includes a disk with a code pattern; and
the sensor assembly includes a light source and a light detector;
where the code pattern alternately interrupts and transmits light between the light source and the light detector as the disk rotates.

5. The rotary encoder assembly of claim 1 where the push on codewheel is made from substantially one material selected from a materials group comprising aluminum, copper, and copper alloy.

6. The rotary encoder assembly of claim 1 where the push on codewheel is retained to the shaft solely by the elastic retention means.

7. A rotary encoder assembly for determining the rotational position of a shaft in a shaft housing comprising:
a push on cap including a magnet, the push on cap frictionally retained to the shaft that rotates in relation to the shaft housing;
an encoder housing mounted to the shaft housing and including an electronics package functionally associated with the magnet that generates an encoder signal in response to rotation of the magnet; and
a lock ring for limiting rotation of the encoder housing.

8. The rotary encoder assembly of claim 7 where partially releasing the lock ring allows rotation of the encoder housing to index the rotary encoder assembly to a shaft position.

9. The rotary encoder assembly of claim 7 where the electronics package includes a hall effect sensor or a coil that is operably connected to a connector providing external access to the encoder signal.

10. The rotary encoder assembly of claim 7 where;
the push on cap is configured as a closed end tube with slits in the tube walls to form biasing members;
assembling the push on cap to the shaft elastically deflects the biasing members;
where when assembled to the shaft the biasing members exert a radial normal force on the shaft.

11. A method of generating an encoder signal of rotation of a shaft comprising:
push a codewheel onto the shaft where the codewheel includes:
an encoding means;
retention means that frictionally retains the codewheel on the shaft;
couple a sensor assembly with the encoding means; and
generate the encoder signal in response to rotation of the encoding means and the shaft in relation to the sensor assembly.

12. The method of generating an encoder signal of claim 11 where the codewheel is comprised substantially from one material selected from the material group of aluminum, copper alloy and clear plastic.

13. The method of generating an encoder signal of claim 11 where the encoding means is a magnet and the sensor assembly includes a component responsive to the magnetic field of the magnet.

14. The method of generating an encoder signal of claim 11 further comprising indexing the sensor assembly to a shaft position.

15. The method of generating an encoder signal of claim 11 where:
the codewheel is a disk;
the encoding means is an encoding pattern that rotates with the disk; and
the sensor assembly includes:
a light source; and
a light detector;
where the encoding pattern intermittently limits light from the light source to the light detector as the shaft rotates.

16. The method of generating an encoder signal of claim 15 where light is transmitted through the disk.

17. The method of generating an encoder signal of claim 15 where light is reflected off a disk face to be received by the light detector.

18. The method of generating an encoder signal of claim 15 where the encoding pattern is on a transparent plastic disk.
